(19) United States
(12) Patent Application Publication
(10) Pub. No.: US 2003/0095687 A1
(43) Pub. Date: May 22, 2003

(54) System and method for generating alert conditions in a surveillance system

(76) Inventor: Dennis L. Montgomery, Reno, NV (US)

Correspondence Address: PILLSBURY WINTHROP, LLP, 1600 Tysons Boulevard, McLean, VA, 22102, US

(21) Appl. No.: 09/991,490

(22) Filed: Nov. 21, 2001

(51) Int. Cl. G06K 9/00

(52) U.S. Cl. 382/103

(57) ABSTRACT

A monitor program in a video surveillance system monitors images coming from one or more surveillance cameras. When an image or set of images satisfies certain conditions, the monitor program takes an appropriate action. For example, in a video surveillance system in a bank, there may be a surveillance camera in the bank's lobby as well as a surveillance camera inside the bank's vault. If, using appropriate pattern recognition techniques, the monitor program recognizes a cleaning person in the lobby doing cleaning, it might not take any action since that would be a legitimate place for the cleaning person to be. If, however, the monitoring system recognized that cleaning person as being in the vault, it might send an alert to the surveillance system operator for further inspection, since cleaning personnel typically should not be in the vault.

### BACKGROUND OF THE INVENTION

1. Field of the Invention

The present invention is directed to a computer system and method for generating alert conditions in a surveillance system. More particularly, it is directed to checking images from a camera producing an image stream and determining whether certain events occur in the images from the camera.

2. Background of the Related Art

Surveillance systems are known in the art. In its simplest form, a surveillance system might essentially consist of an analog video camera hooked up to a remote video monitor as shown in FIG. 1A or a microphone attached to a recorder, or a combination of both. Fort he discussion hereinafter, a camera will be described. The camera is pointed at a spot of interest, e.g., a front door, an automated teller machine, etc., and provides an image of that scene to the monitor. An operator watches the monitor to look for unusual or unauthorized behavior at the scene. If such activity is perceived, the operator takes appropriate action—identifying the individual, notifying security police, etc.

The system may have one or many cameras, each of which can be displayed in a predetermined area of the monitor. Alternatively, the operator may toggle through the scenes. Further, instead of one or more analog cameras, the system may use digital cameras such as CCD cameras and the like. Such digital cameras have the advantage of providing a high-quality, low-noise image when compared to analog images.

Another possible video surveillance arrangement is shown in FIG. 1B. This system uses multiple cameras connected to the monitor via a controller. The controller can multiplex several camera signals and provide them to the monitor. Also, it can control the positions of the cameras. The operator uses an input device such as a keyboard, joystick or the like to direct the controller to control the motion of the cameras so they point to particular areas within their range, track interesting features in the images, etc. It may also use the input device to control the controller to direct the controller to provide particular ones of the camera signals to the monitor.

FIG. 1C shows another arrangement of a video surveillance system. Here, a video recording device is connected to the camera outputs, the monitor input, or both. The video recording device, e.g., a video cassette recorder for analog cameras, can record the camera signals for archival, later review, and the like. Further, it can record images displayed on the monitor as evidence of activities taking place in the environments being inspected. For digital systems, the video storage device may be a digital storage device, a mass storage device such as a hard disk drive, or the like. When a hard disk drive is used, it may be a separate unit from the user controller and camera controller, or it may be part of an integrated system.

Even though video surveillance systems can handle multiple cameras and store images therefrom, it is typically the responsibility of the system operator to review the images from the cameras and determine whether anything which should be investigated in greater detail has occurred. Video surveillance systems typically do not have any facility for image recognition. Even when a video surveillance system include pattern recognition capability, it is typically extremely limited—for example, a camera may be focused on the license plates of cars passing through a toll booth gate, and the pattern recognition is limited to recognizing letters and digits on the license plate. For many other applications, more sophisticated types of pattern recognition are desirable but are not readily available in the prior art.

### SUMMARY OF THE INVENTION

In view of the above problem of the prior art, it is an object of the present invention to provide a system and method for generating and managing alert conditions in a video surveillance system.

The above object is achieved in one embodiment of the present invention by providing a monitor program which monitors images coming from one or more surveillance cameras. When an image or set of images satisfies certain conditions, the monitor program takes an appropriate action.

### BRIEF DESCRIPTION OF THE DRAWINGS

The invention will be more easily understood in view of the following detailed description and the appended drawings, in which:

FIGS. 1A-1C show various video surveillance system arrangements; and

FIG. 2 shows a video surveillance system according to an embodiment of the present invention.

### DETAILED DESCRIPTION OF PRESENTLY PREFERRED EXEMPLARY EMBODIMENTS

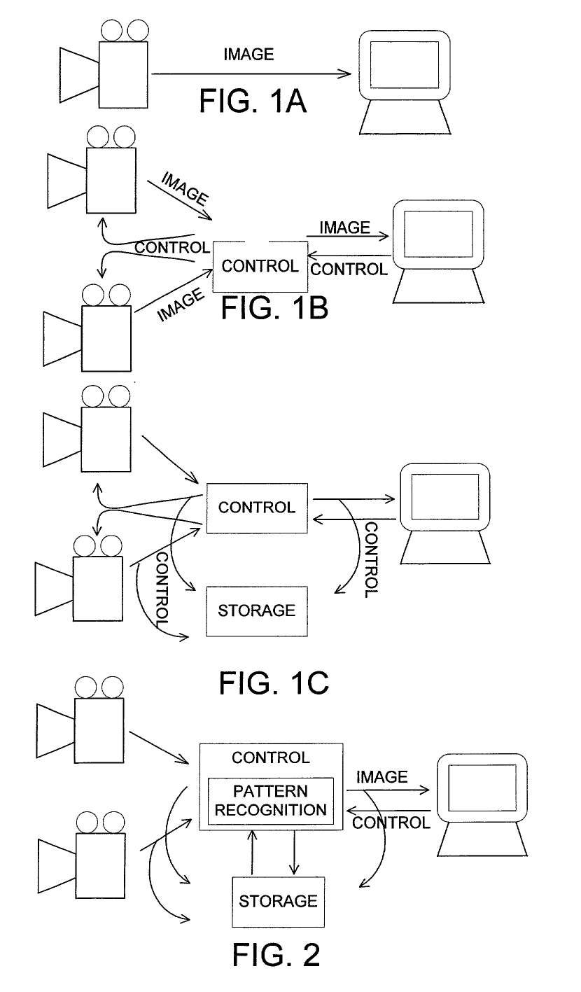

FIG. 2 shows a video surveillance system according to an embodiment of the present invention. This system is similar to the one shown in FIG. 1C, with the exception that in addition to controlling the positions of the cameras and supplying the camera signals to the monitor, the controller also monitors images produced by the cameras for certain conditions as specified by rules set by the video surveillance system operator, and produces alerts, also called alarms, or the like when one of those conditions is met. Alternatively, the monitoring program need not be in the controller, but may be separate and monitor images in the digital storage device after storage.

Regardless of where the monitoring is done, the base of the monitoring program lies in its pattern recognition of image features. Typically, pattern recognition as used herein is capable of identifying people based on a shot of their face in an image, etc. Further, the pattern recognition system can also resolve objects, such as purses, briefcases, individual cards, betting chips. The degree of resolution, of course depends upon many factors, as is known. All such things that might be the object of pattern recognition will sometimes be referred to as entities in the following discussion and claims.

Pattern recognition can be based on a single image, e.g., “If the custodian is in the vault shot, notify the system operator”, or it can be based on multiple images, e.g., “If John Doe and Joe Smith (two suspected bank robbers) are in the lobby shot at time T1 and only John Doe is in the lobby shot at a later time T2, then notify the system operator and start looking for Joe Smith.”

The basic pattern recognition expressions are

IF P1 AND P2 AND P3 . . . THEN Q1 AND Q2 AND Q3 (1)

and

IF P1 OR P2 OR P3 . . . THEN Q1 AND Q2 AND Q3 (2)

For example, in the setting of a casino, the monitor program may have a rule such as

IF (image shows a person on a list of known card counters) THEN (notify system operator) (3)

where there is one P and one Q. Alternatively, a rule may be of the conjunctive form

IF (image at time T1 shows card counter A) AND (image at time T1 shows card counter B) AND (image at time T2 shows card counter A) AND (image at time T2 does not show card counter B) THEN (notify system operator) AND (notify casino security) (4)

Alternatively, the rule may be a disjunctive one such as

IF (image shows game dealer in cashier area) OR (image shows game dealer in vault area) THEN (notify system operator) (5)

Some other alarm generation recognition rules that might arise in these situations include:

IF (at time T1 object or person A is in a first image shot) AND (at time T1 object or person B is in the first image shot) AND (at time T2 object or person A is in a second image shot) AND (at time T2 object or person B is not in the second image shot) THEN generate an alarm) (6)

IF (at time T1 object A is in a first image shot) AND (at time T1 object B is not in the first image shot) AND (at time T1 object A is in a second image shot) AND (at time T2 object B is in the second image shot) THEN (generate an alarm) (7)

An example of this rule is at various airport security check-in locations. At an initial entry position, a person A is photographed carrying no objects. At another location, such as an entryway onto an airplane, another photograph shows person A with an object B, which can be used to generate an alarm showing a changed condition.

IF (object or person A is in an image shot of a place where the object or person is not permitted to be) THEN (generate an alarm) (8)

Examples of this rule are:

IF ($1000 betting chip is in area other than high stakes betting area) THEN (generate alarm) (9)

or

IF (kitchen worker is in area other than kitchen) THEN (generate an alarm) (10)

IF (person or object A is in an image of a scene) AND (person or object A is on a list of people or objects of a certain type) AND (person or object B is also on the list of people or object of that certain type) THEN (generate an alarm) AND (look for person or object B in the image) (11)

With respect to the above rule (11), a modification of the rule also provides for the inclusion of alternative or alias information concerning a specific person or object. Accordingly, the group information can also include alternative or alias information. Thus, if photographs of the same person, one with a beard or sunglasses and one without a beard or sunglasses exist, then both of the photographs can be associated with that person and searched when searching for that person. The same alternative information can also be stored with respect to objects. A modification of this rule, for example purposes using only person identities is:

IF (person A is in an image of a scene) AND (person A is on a list of known or suspected terrorists) AND (person B is also on the list of known or suspected terrorists) THEN (generate an alarm) AND (look for person B in the image) (12)

This pattern recognition process may be done on images in the video surveillance system a single time. Alternatively, it may be done periodically, or on a continuous basis Further, the rules can have time limits. For example, a rule may specify that if a person A is recognized in an image, the system will search for a person B in images for 15 minutes therefrom and, if person B is found within that time, a certain action will be taken.

The embodiments described above have been presented for purposes of explanation only, and the present invention should not be construed to be so limited. Variations on the present invention will become readily apparent to those skilled in the art after reading this description, and the present invention and appended claims are intended to encompass such variations as well.

What is claimed is:

1. A system for generating an alert in a video surveillance unit, the system comprising:
access means for accessing sequences of digital images;
pattern recognition means for recognizing an entity in at least one digital image from the sequences of digital images;
rule application means for applying rules relating to entities potentially appearing in the at least one digital image, the rules pertaining to at least one entity; and
means for generating the alert responsive to the at least one digital image satisfying one or more of the rules.

2. The system of claim 1, wherein the rules include a rule specifying the generation of the alert when the entity in the at least one digital image is recognized by the pattern recognition means as corresponding to a tracked entity.

3. The system of claim 1, wherein the rules include a rule specifying the generation of the alert when two entities in a first digital image are recognized by the pattern recognition means as being entities to be tracked, and only one of those entities is recognized as being in a subsequent second digital image.

4. The system of claim 1, wherein the rules include a rule specifying the generation of the alert when an entity is recognized by the pattern recognition means as being in the at least one digital image corresponding to an area in which the entity is not supposed to be.

5. The system of claim 1, wherein the rules include a rule specifying the generation of the alert when a first entity is recognized by the pattern recognition means as being in a first digital image, and the first entity and a second entity are recognized by the pattern recognition means as being in a subsequent second digital image.

6. The system of claim 1, wherein the rules include a rule where, when the pattern recognition means recognizes a first entity in the at least one digital image, a search is initiated to look for a second entity in other digital images.

7. The system of claim 6, wherein the rule further specifics the generation of the alert if the second entity is recognized by the pattern recognition means as being within at least one of the other digital images.

8. The system of claim 1, wherein the rules include a rule where the generation of the alert is specified when a first condition is satisfied at a first time, and a second condition is satisfied at a second time different from the first time.
